(19) United States
(12) Patent Application Publication
(10) Pub. No.: US 2025/0287488 A1
(43) Pub. Date: Sep. 11, 2025

(54) LIGHTING DEVICE FOR BEVERAGE CONTAINER, LIGHTING SYSTEM FOR BEVERAGE CONTAINER AND METHOD OF LIGHTING IN BEVERAGE CONTAINER

(71) Applicant: George STANTCHEV, Phoenix, AZ (US)

(72) Inventor: George STANTCHEV, Phoenix, AZ (US)

(21) Appl. No.: 19/216,722

(22) Filed: May 23, 2025

Related U.S. Application Data
(60) Provisional application No. 63/424,272, filed on Nov. 10, 2022.

(51) Int. Cl. H05B 47/12; A47G 19/22; F21L 4/08; F21V 23/02; F21V 23/04; F21Y 115/10; H05B 45/12; H05B 45/20; H05B 47/11; H05B 47/175; H05B 47/19

(52) U.S. Cl. CPC H05B 47/12; A47G 19/2227; F21L 4/08; F21V 23/023; F21V 23/0421; F21V 23/0485; H05B 45/12; H05B 45/20; H05B 47/11; H05B 47/19; H05B 47/1965; H05B 47/197; A47G 2019/2238; F21Y 2115/10

(57) ABSTRACT

A lighting device for a beverage container includes a base, at least one light source, a wireless transceiver, and a microprocessor. The base is affixed to the beverage container. At least one light source is disposed on the base and is configured to emit light. The wireless transceiver is disposed within the base and is configured to receive audio information and sensing information. The microprocessor is disposed within the base, is electrically connected to at least one light source and the wireless transceiver, and controls at least one light source to change at least one of the colors, the light intensity and the operation frequency of the light according to the audio information and the sensing information. Based on the aforementioned configuration, the pattern of the light varies within the beverage container according to the audio information and the sensing information, thereby creating vibrant visual experience.

### TECHNICAL FIELD OF THE INVENTION

This non-provisional application claims priority claim under 35 U.S.C. § 119 (a) on U.S. Provisional Patent Application No. 63/424,272 filed Nov. 10, 2022 the entire contents of which are incorporated herein by reference. The present disclosure is related to the technical field of the dynamic landscape of beverage containers in consumer markets and is particularly directed to a lighting device for a beverage container, a lighting system for a beverage container and a method of lighting in a beverage container.

### DESCRIPTION OF THE PRIOR ART

The current trend of beverage containers in consumer markets focuses on the various applications of wireless technologies such as Bluetooth in beverage containers. For example, U.S. Pat. No. 9,004,320B2 describes a mechanism to control the flow of a beverage from a bottle by the wireless communication between a pour spout and a control unit, and U.S. Pat. No. 11,237,036B2 describes a mechanism to monitor the content of a container by a sensor device.

However, there is no development or product about the beverage container to create a direct consumer connection which fosters the real-time interaction between a consumer and the beverage container. How to create the direct consumer connection in the beverage container becomes an important issue.

### SUMMARY

In light of the aforementioned descriptions, the present disclosure provides a lighting device for a beverage container, a lighting system for a beverage container and a method of lighting in a beverage container to solve the problem in creating the direct consumer connection in the beverage container.

Based on the aforementioned descriptions, the present disclosure provides the lighting device for the beverage container. The lighting device for the beverage container includes a base, at least one light source, a wireless transceiver and a microprocessor. The base is affixed to the beverage container. At least one light source is disposed on the base and is configured to emit light. The wireless transceiver is disposed within the base and is configured to receive audio information and sensing information. The microprocessor is disposed within the base, is electrically connected to at least one light source and the wireless transceiver, and controls at least one light source to change at least one of the colors, the light intensity and the operation frequency of the light according to the audio information and the sensing information.

Based on the aforementioned descriptions, the present disclosure provides the lighting system for the beverage container. The lighting system for the beverage container includes an electronic device and the lighting device. The electronic device transmits audio information and sensing information. The lighting device communicates with the electronic device and includes a base, at least one light source, a wireless transceiver and a microprocessor. The base is affixed to the beverage container. At least one light source is disposed on the base and is configured to emit light. The wireless transceiver is disposed within the base and is configured to receive audio information and sensing information. The microprocessor is disposed within the base, is electrically connected to at least one light source and the wireless transceiver, and controls at least one light source to change at least one of the colors, the light intensity and the operation frequency of the light according to the audio information and the sensing information.

Based on the aforementioned descriptions, the present disclosure provides the method of lighting in the beverage container. The method of lighting in the beverage container is for a lighting system, and the lighting system includes an electronic device and a lighting device, and the lighting device is configured to emit light and is affixed to the beverage container. The method of lighting in the beverage container includes performing steps as follows by the lighting device: receiving audio information and sensing information from the electronic device; according to the audio information and sensing information, changing at least one of the colors, the light intensity and the operation frequency of the light.

In view of the above description, in the lighting device for the beverage container, the lighting device and the beverage container integrate seamlessly, and the pattern of the light varies within the beverage container according to the audio information and the sensing information, thereby creating vibrant visual experience, thus enhancing the user experience of the beverage container with the lighting device and encouraging interactive communication with customers.

In view of the above description, in the lighting system for the beverage container and the method of lighting in the beverage container, the lighting device receives plenty of real-time data such as the audio information and the sensing information from the electronic device to synchronize the pattern of the light with the music in the audio information and to transform the sensing information into the dynamic pattern of the light, thereby fostering an enriching experience with the beverage container having the lighting device.

In addition, when the beverage container with the lighting device is exhibited, the beverage container with the lighting device not only engage consumers at a deeper level but also transforms the consumer behavior of purchasing and experiencing beverage in the beverage container into a more immersive and enjoyable journey.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1A depicts a schematic diagram of a lighting system for a beverage container according to one embodiment of the present disclosure.

FIG. 1B depicts the block diagram of the lighting device for the beverage container shown in FIG. 1A.

FIG. 2A depicts a schematic diagram of a lighting system for a beverage container according to another embodiment of the present disclosure.

FIG. 2B depicts the block diagram of the lighting device for the beverage container shown in FIG. 2A.

FIG. 2C depicts the block diagram of the electronic device shown in FIG. 2A.

FIG. 3 depicts a flowchart of a method of lighting in a beverage container according to one embodiment.

FIG. 4 depicts a flowchart of a method of lighting in a beverage container according to another embodiment.

FIG. 5 depicts a flowchart of a method of lighting in a beverage container according to yet embodiment.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

It should be noted that the terms “first”, “second”, etc. in the specification and claims of the present disclosure and in the aforementioned accompanying drawings are used to distinguish similar objects and not used to describe a particular order or sequence. Furthermore, the terms “comprising” and “having”, and any variation thereof, are intended to encompass a non-exclusive inclusion, for example, a series of steps or units comprising processes, methods, systems, products or equipment do not need to be limited to those steps or units clearly listed but may include other steps or units not clearly listed or inherent to those processes, methods, products or equipment.

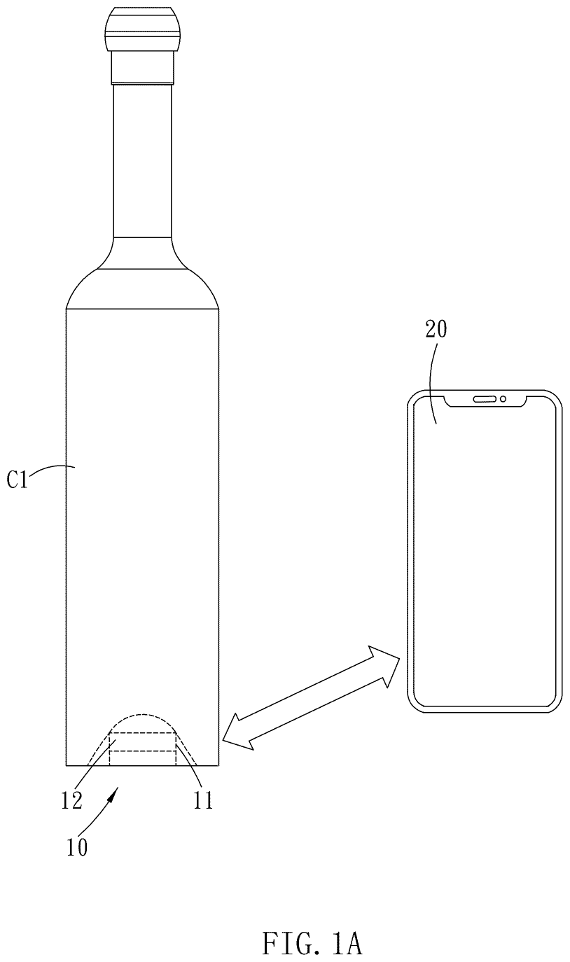

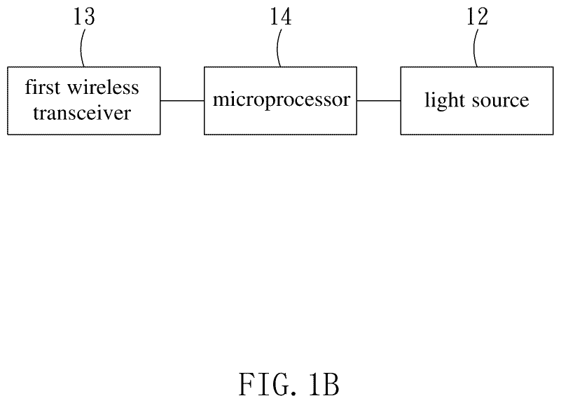

Please refer to FIG. 1A, which depicts a schematic diagram of a lighting system for a beverage container according to one embodiment of the present disclosure. As shown in FIG. 1A, a lighting system for a beverage container C1 includes a lighting device 10 and an electronic device 20. The beverage container C1 accommodates a beverage such as milk, coffee and whisky and may be a bottle or a glass container.

The electronic device 20 is wirelessly connected to the lighting device 10 to communicate with the lighting device 10 and may be a mobile phone, a computer or a smart speaker. The wireless connection between the electronic device 20 and the lighting device 10 may be but not be limited to a Bluetooth connection, a Wi-Fi connection, or a ZigBee connection. The electronic device 20 transmits plenty of data to the lighting device 10 by the wireless connection to build a data-rich environment for the lighting device 10, and the plenty of data include audio information, sensing information and the other types of information.

The lighting device 10 is embedded within the beverage container C1 for ornamental lighting and is located on the bottom of the beverage container C1, for example, but the position of the lighting device 10 may be changed to the sidewall of the beverage container C1 and not be limited thereto. The light device 10 is configured to generate light to illuminate the interior of the beverage container C1 and varies the pattern and the mode of the light according to the audio information and the sensing information to provide an interactive user experience and to enhance the visual experience of the light. Hence, the pattern and the mode of the light are influenced by the audio information and the sensing information. In other words, the electronic device 20 indirectly controls the pattern and the mode of the light and is regarded as the controller for the pattern and the mode of the light.

Please refer to FIG. 1B, which depicts the block diagram of the lighting device for the beverage container shown in FIG. 1A. As shown in FIG. 1B, in conjunction with FIG. 1A, the lighting device 10 includes a base 11, at least one light source 12, a first wireless transceiver 13 and a microprocessor 14.

The base 11 is affixed to the beverage container C1. Specifically, the base 11 is fixed at the bottom of the beverage container C1 by snap-fit structures and is located at a recess on the bottom of the beverage container C1. The interior of the base 11 accommodates at least one light source 12, the first wireless transceiver 13 and the microprocessor 14. The bottle preferably has special design printed on the glass that makes the light from the base 11 illuminate all its ornamentals and create elevating lightning show effects.

At least one light source 12 is disposed on the base 11, is electrically connected to the microprocessor 14, and is configured to emit the light. In present embodiment, at least one light source 12 is disposed within the base 11 and is located on the interior of the base 11. In another embodiment, at least one light source 12 protrudes from the top surface of the base 11 and contacts the recess on the bottom of the beverage container C1. At least one light source 12 is controlled by the microprocessor 14 to selectively emit light, and the color, the light intensity, and the operation frequency of the light is determined by the microprocessor 14. At least one light source 12 may be one or more light-emitting diodes (LEDs), and the color of at least one light source 12 may be single or multiple, thereby providing versatile illumination options. In the present embodiment, the number of at least one light source 12 is one, and the color of the light source 12 is single or multiple. In another embodiment, the number of at least one light source 12 is plural, and the color of each light source 12 is single.

The first wireless transceiver 13 is disposed within the base 11; in other words, the first wireless transceiver 13 is located on the interior of the base 11. The first wireless transceiver 13 is electrically connected to the microprocessor 14, and is configured to receive the plenty of data including the audio information and the sensing information from the electronic device 20. Specifically, the first wireless transceiver 13 serves as the IoT (Internet of Things) interface of the lighting device 10 to enable the remote control and the monitoring of the electronic device 20. The communication protocol of the first wireless transceiver 13 may be but not be limited to Bluetooth or Wi-Fi.

The microprocessor 14 is disposed within the base; in other words, the microprocessor 14 is located on the interior of the base 11. The microprocessor 14 controls the operation of the light source 12 and the operation of the first wireless transceiver 13, and controls the light source 12 to change at least one of the colors, the light intensity, and the operation frequency of the light according to the audio information and the sensing information. The details of controlling the light source 12 to change at least one of the colors, the light intensity, and the operation frequency of the light according to the audio information and the sensing information would be elaborated in the paragraphs of a method of lighting in a beverage container.

In the present embodiment, there is a circuit board on the interior of the base 11, and the circuit board may be but not be limited to a printed circuit board (PCB) or a flexible printed circuit board (FPCB). The first wireless transceiver 13 and the microprocessor 14 are disposed on the circuit board, and the light source 12 and the first wireless transceiver 13 are electrically connected to the microprocessor 14 by conductive wires.

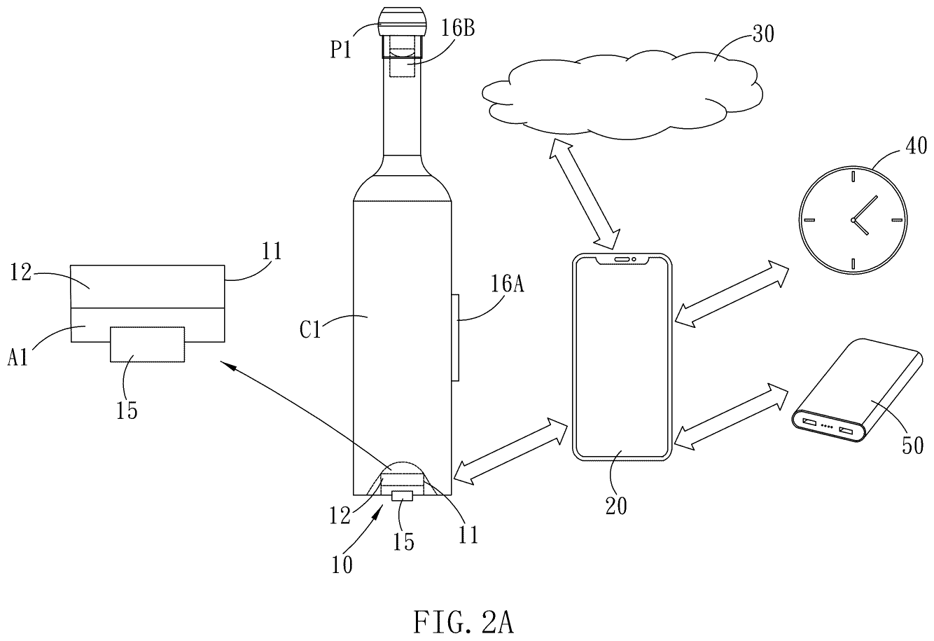

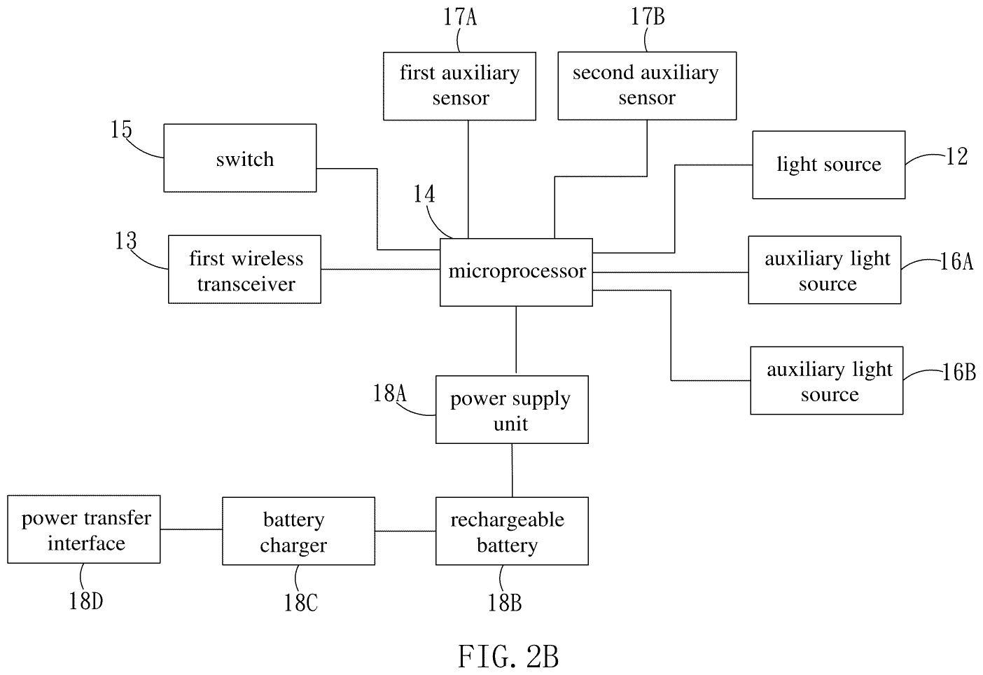

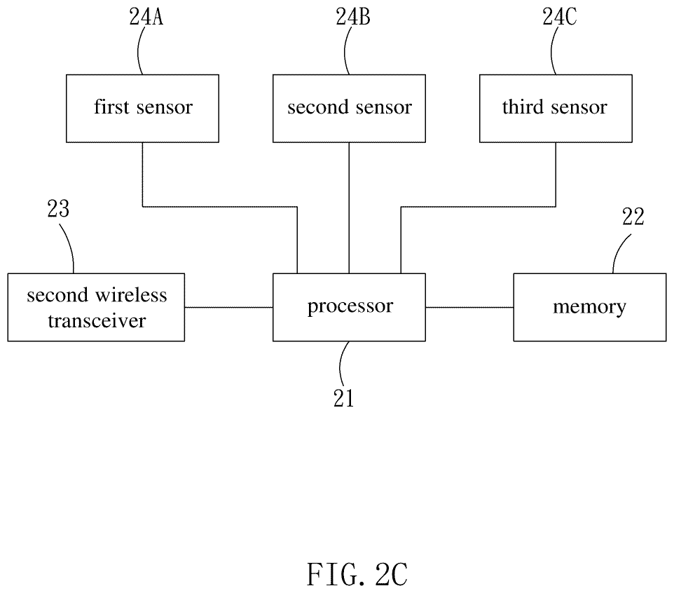

Please refer to FIG. 2A, which depicts a schematic diagram of a lighting system for a beverage container according to another embodiment of the present disclosure. As shown in FIG. 2A, a lighting system for a beverage container C1 includes the lighting device 10 and the electronic device 20. The similarities between the configuration of FIG. 1A and the configuration of FIG. 2A would not be repeated.

The electronic device 20 is connected to a cloud server 30 and a media input source 40 by Internet, is connected to an external storage device 50 by a universal serial bus (USB) connector and a USB cable, and obtains environment information and the audio information from the cloud server 30, the media input source 40 and the external storage device 50. In other words, the electronic device 20 serves as an IoT-enabled device.

The environment information may include weather information, time information and geographical information which are changed according to the geographical position of the electronic device 20. The weather information includes the different weather of the different geographical positions, and the time information includes the different time of the different geographical positions. The geographical information includes the different local cultures at the different geographical positions, the different ambiances of specific neighborhoods or street clubs at the different geographical positions, and the different local festivals at the different geographical positions. The audio information includes user music, popular music, local music and the other audio files. It should be noted that the user music may be previously stored in the electronic device 20 or be obtained from the external storage device 50.

In addition, the electronic device 20 is provided with application software. The application software establishes a straightforward connection to the cloud server 30, the media input source 40, and the external storage device 50 and gathers user information and the sensing information in the electronic device 20 to assist a user in controlling the lighting of the lighting device 10. In other words, the application software empowers the user to control the lighting of the lighting device 10. For example, the electronic device 20 is a smart phone, and the application software is a phone application. The phone application assists the user in collecting the user information, the sensing information, and the audio information and remotely controlling the operation of the lighting device 10.

The cloud server 30 is a cloud platform which grants the electronic device 20 access to various internet radio stations spanning diverse music styles or cloud music service, and the electronic device 20 obtains the popular music, the local music, and the other audio files from the cloud server 30. The popular music, the local music and the other audio files constitute one part of the audio information. In addition, the cloud server 30 stores various light templates and the geographical information, and the electronic device 20 is able to capture the needed light template from the cloud server 30 according to user requirements and to select the corresponding local culture and the corresponding ambiance of specific neighborhoods or street clubs from the cloud server 30 according to the geographical position of the electronic device 20 to assist the user in the customization of the lighting effects of the lighting device 10.

The media input source 40 is an information station to provide the electronic device 20 with the weather information and the time information to assist the user in selecting the appropriate music from the audio information. In addition, the electronic device 20 is able to capture the local news of the geographical position of the electronic device 20 from the media input source 40 to assist the user in confirming what event occurs. The media input source 40 may be a home weather station, a smart connected clock station, or a television (TV) station, and the number of the media input source 40 may be one or more.

The external storage device 50 provides the electronic device 20 with the user music to assist the user in the personalization of the lighting effects of the lighting device 10. In addition, the electronic device 20 is able to capture a user video from the external storage device 50 to assist the user in the personalization of the lighting effects of the lighting device 10. The user music and the user video constitute the other part of the audio information. The external storage device 50 is a portable storage device or a USB flash drive.

In addition, the user uses the application software in the electronic device 20 to automatically gather or collect the user information, the sensing information, the audio information and the environment information, and the application software provides the appropriate light templates for the user according to the user information, the sensing information, the audio information, and the environment information. When the lighting device 10 is provided in plural, the user uses the application software to indirectly control the operation of the lighting devices 10 or to control the lighting devices 10 to operate according to the light template which the user selects.

According to the above descriptions, the electronic device 20 can retrieve and play any available music files stored in the cloud server 30 and the external storage device 50 according to the user requirements, thereby broadening the listening options of the user and catering to user preferences. In addition, the application software may integrate a wealth of music according to the user requirements to facilitate the customization of the lighting effects of the lighting device 10.

Please refer to FIG. 2B, which depicts the block diagram of the lighting device for the beverage container shown in FIG. 2A. As shown in FIG. 2B, in conjunction with FIG. 2A, the lighting device 10 includes a base 11, at least one light source 12, the first wireless transceiver 13, the microprocessor 14, a switch 15, auxiliary light sources 16A and 16B, at least one auxiliary sensor, a power supply unit 18A, a rechargeable battery 18B, a battery charger 18C, a power transfer interface 18D, and an attaching surface A1. The configurations of the base 11, at least one light source 12, the first wireless transceiver 13 and the microprocessor 14 shown in FIG. 2A and FIG. 2B is similar to the configurations of the base 11, at least one light source 12, the first wireless transceiver 13 and the microprocessor 14 shown in FIG. 1A and FIG. 1B and would not be repeated. In the present embodiment, the number of at least one auxiliary sensor is two, two auxiliary sensors are a first auxiliary sensor 17A and a second auxiliary sensor 17B. However, the number of at least one auxiliary sensor may be adjusted according to the requirements of the lighting device 10 and may be one, three or more than three, and the present disclosure is not limited thereto.

The attaching surface A1 is disposed under the bottom surface of the base 11 to be attached to the beverage container C1, and the bottom surface of the beverage container C1 contacts the attaching surface A1, thus allowing for the easy attachment of the base 11 to the surfaces of the various bottles or the various glass containers. The materials of the attaching surface A1 may include but not be limited to friction materials or adhesive materials, and the adhesive materials may include a hot-melt adhesive or a UV adhesive, for example.

The switch 15 is disposed adjacent to the base 11 and is electrically connected to the microprocessor 14. Specifically, the switch 15 is disposed under the bottom surface of the base 11, one part of the switch 15 contact the attaching surface A1, and the other part of the switch 15 protrudes from the bottom of the attaching surface A1 and is exposed to air. There are the conductive wires which start from the microprocessor 14 and penetrate the attaching surface A1 to contact the switch 15, and the conductive wires penetrating the attaching surface A1 connect the switch 15 and the microprocessor 14.

The switch 15 is configured to generate a trigger signal. In the present embodiment, the switch 15 is provided with an on button and an off button. When the on button is pressed, the switch 15 generates and transmits the trigger signal to the microprocessor 14, and the microprocessor 14 controls at least one light source 12 to be turned on. When the off button is pressed, the switch 15 does not generate the trigger signal, and the microprocessor 14 controls at least one light source 12 to be turned off. In other words, the microprocessor 14 controls at least one light source 12 to be turned on or be turned off according to the trigger signal. In another embodiment, the switch 15 is a multi-step switch. The switch 15 is configured to generate and transmit the different trigger signals to the microprocessor 14 according to different touch actions, and the microprocessor 14 generates and transmits different control signals to at least one light source 12. Afterwards, at least one light source 12 generates the different patterns of the light according to the different control signals, and the different patterns of the light may include static illumination, strobe effects, color transitions, etc.

The auxiliary light source 16A is disposed on the sidewall of the beverage container C1, while the auxiliary light source 16B is disposed adjacent to the cap P1 of the beverage container C1. It should be noted that the positions of the auxiliary light sources 16A and 16B in FIG. 2A are exemplary and are not limited thereto. The auxiliary light sources 16A and 16B are electrically connected to the microprocessor 14 and are controlled by the microprocessor 14. The light emitted from the light source 12 is main light, while the light emitted from the auxiliary light sources 16A and 16B is auxiliary light. The auxiliary light sources 16A and 16B assist the light source 12 in the different patterns of the light. In addition, the auxiliary light sources 16A and 16B may have their own switches to facilitate the control of the auxiliary light. In collaboration with the light source 12 and the auxiliary light sources 16A and 16B, the colors of the light may encompass a palette of colors.

The first auxiliary sensor 17A is located on the interior of the base 11 and is electrically connected to the microprocessor 14. The microprocessor 14 controls the operation of the first auxiliary sensor 17A, and when the first auxiliary sensor 17A generates first auxiliary sensing information according to the environment of the lighting device 10, the microprocessor 14 receives the first auxiliary sensing information from the first auxiliary sensor 17A and controls the light source 12 to change at least one of the color, the light intensity or the operation frequency of the light according to the first auxiliary sensing information. For example, the first auxiliary sensor 17A is a microphone, and the first auxiliary sensing information includes the frequency and the sound level (e.g., sound pressure level, SPL) of ambient sound around the environment of the lighting device 10. The microprocessor 14 controls the light source 12 to change the color and the light intensity of the light according to the frequency and the sound level of ambient sound to realize dynamic light manipulation. When the ambient sound is live music, the first auxiliary sensor 17A assists the microprocessor 14 in synchronizing the patterns of the light with the live music.

The second auxiliary sensor 17B is located on the interior of the base 11 and is electrically connected to the microprocessor 14. The microprocessor 14 controls the operation of the second auxiliary sensor 17B, and when the second auxiliary sensor 17B generates second auxiliary sensing information according to the environment of the lighting device 10, the microprocessor 14 receives the second auxiliary sensing information from the second auxiliary sensor 17B and controls the light source 12 to change at least one of the color, the light intensity or the operation frequency of the light according to the second auxiliary sensing information. For example, the second auxiliary sensor 17B is an ambient light sensor, and the second auxiliary sensing information includes the ambient light intensity of ambient light. The microprocessor 14 controls the light source 12 to change the light intensity of the light according to the ambient light intensity of the ambient light.

The power supply unit 18A is disposed within the base 11 and is electrically connected to the light source 12, the first wireless transceiver 13, the microprocessor 14, the auxiliary light sources 16A and 16B, the first auxiliary sensor 17A, the second auxiliary sensor 17B, and the rechargeable battery 18B. It should be noted that the connection between the power supply unit 18A and the light source 12, the connection between the power supply unit 18A and the first wireless transceiver 13, the connection between the power supply unit 18A and the auxiliary light source 16A, the connection between the power supply unit 18A and the auxiliary light source 16B, the connection between the power supply unit 18A and the first auxiliary sensor 17A, and the connection between the power supply unit 18A and the second auxiliary sensor 17B are omitted in order to simplify FIG. 2B. The power supply unit 18A receives electricity from the rechargeable battery 18B and distributes the electricity to the light source 12, the first wireless transceiver 13, the microprocessor 14, the auxiliary light sources 16A and 16B, the first auxiliary sensor 17A, the second auxiliary sensor 17B. The power supply unit 18A may be a power management integrated circuit (PMIC), for example.

The rechargeable battery 18B is disposed within the base 11 and is electrically connected to the battery charger 18C to receive charging power. The rechargeable battery 18B generates electricity to power the light source 12, the first wireless transceiver 13, the microprocessor 14, the auxiliary light sources 16A and 16B, the first auxiliary sensor 17A, the second auxiliary sensor 17B, thus ensuring the sustainable operation of the lighting device 10. For example, the rechargeable battery 18B may be a Li-based battery, Li-ion battery, a NiMH battery, or any other suitable chemistry battery.

The battery charger 18C is disposed within the base 11 and is electrically connected to the power transfer interface 18D. The battery charger 18C receives external power from the power transfer interface 18D and generates the charging power according to the external power in order to charge the rechargeable battery 18B.

The power transfer interface 18D is disposed on the base 11 and is configured to receive the external power. In one embodiment, the power transfer interface 18D is a wire power transfer interface, and the wire power transfer interface is a USB interface or a hot-plug interface, for example. The USB interface is connected to the USB cable to receive the external power from a USB socket. In another embodiment, the power transfer interface 18D is a wireless power transfer interface, the wireless power transfer interface receives the external power from a portable charger by the electromagnetic induction of magnetic coils. In yet embodiment, the power transfer interface 18D is provided in two, one power transfer interface 18D is the wire power transfer interface, and the other power transfer interface 18D is the wireless power transfer interface. Two power transfer interface 18D may utilize the wired connection or the wireless connection to energize the lighting device 10 during operation or charging.

Please refer to FIG. 2C, which depicts the block diagram of the electronic device shown in FIG. 2A. As shown in FIG. 2C, the electronic device 20 includes a processor 21, a second wireless transceiver 22, a memory 23 and a plurality of sensors. In the present embodiment, the number of the plurality of sensors is three, and three sensors are a first sensor 24A, a second sensor 24B and a third sensor 24C. However, the number of the plurality of sensors may be adjusted according to the requirements of the electronic device 20 and may be two, four or more than four, and the present disclosure is not limited thereto. The following would elaborate the configuration of the electronic device 20 in conjunction with FIG. 2A to FIG. 2C.

The processor 21 is electrically connected to the second wireless transceiver 22, the memory 23, the first sensor 24A, the second sensor 24B and the third sensor 24C, and the second wireless transceiver 22, the first sensor 24A, the second sensor 24B and the third sensor 24C are controlled by the processor 21. The memory 22 stores user information and/or the user music, and the user information includes user music libraries, user broadcasts, user schedule, user habits, etc. The memory may be a flash memory, a hard disk drive (HDD), solid-state disk (SSD), a dynamic random access memory (DRAM), or a static random access memory (SRAM). The processor 21 is able to access the user information from the memory 22 and integrates the audio information, the sensing information, the user information and the environment information into a packet.

The second wireless transceiver 23 is wirelessly connected to the first wireless transceiver 13 (referring to FIG. 2B) to realize the communication between the electronic device 20 and the lighting device 10 (referring to FIG. 2A). In addition, the second wireless transceiver 23 is wirelessly connected to the cloud server 30 and the media input source 40 to receive the one part of the audio information and the environment information. The processor 21 controls the second wireless transceiver 23 to transmit the packet to the first wireless transceiver 13. In other words, the second wireless transceiver 23 serves as the IoT interface of the electronic device 20. The communication protocol of the second wireless transceiver 23 may be but not be limited to Bluetooth or Wi-Fi.

The first sensor 24A generates a first sensing signal, and the processor 21 controls the second wireless transceiver 23 to transmit the first sensing signal to the first wireless transceiver 13 (referring to FIG. 2B), and the microprocessor 14 controls the light source 12 and the auxiliary light sources 16A and 16B to change the color of the light, the light intensity of the light or the operation frequency of the light according to the first sensing signal. It should be noted that the first sensing signal is one part of the sensing information. For example, the first sensor 24A is a velocity sensor, and the first sensing signal represents velocity information. The microprocessor 14 controls the light source 12 and the auxiliary light sources 16A and 16B to change the operation frequency of the light and/or the color of the light according to the velocity information.

The second sensor 24B generates a second sensing signal. It should be noted that the second sensing signal is another part of the sensing information. For example, the second sensor 24B is a GPS sensor, and the second sensing signal represents location information. The location information includes the geographical orientation of the electronic device 20 and the geographical position of the electronic device 20. The processor 21 selects the local music according to the geographical orientation of the electronic device 20 and the geographical position of the electronic device 20 and transmits the local music to the lighting device 10 by the second wireless transceiver 23. The microprocessor controls the light source 12 and the auxiliary light sources 16A and 16B to change at least one of the colors, the light intensity and the operation frequency of the light according to the local music.

The third sensor 24C generates a third sensing signal, and the processor 21 controls the second wireless transceiver 23 to transmit the third sensing signal to the first wireless transceiver 13 (referring to FIG. 2B), and the microprocessor 14 controls the light source 12 and the auxiliary light sources 16A and 16B to change the color of the light, the light intensity of the light or the operation frequency of the light according to the third sensing signal. It should be noted that the third sensing signal is the other part of the sensing information. For example, the third sensor 24C is an accelerometer, and the third sensing signal represents acceleration information. The microprocessor 14 controls the light source 12 and the auxiliary light sources 16A and 16B to change the operation frequency of the light and/or the color of the light according to the acceleration information.

In one embodiment, the processor 21 obtains the user information from the memory 22, selects the user music from the audio information according to the user information, and controls the second wireless transceiver 23 to transmit the user music to the first wireless transceiver 13 (referring to FIG. 2B). The microprocessor 14 controls the light source 12 and the auxiliary light sources 16A and 16B to change at least one of the colors of the light, the light intensity of the light, and the operation frequency of the light according to the user music.

In another embodiment, the processor 21 obtains the user music from the memory 22 and controls the second wireless transceiver 23 to transmit the user music to the first wireless transceiver 13 (referring to FIG. 2B). The microprocessor 14 controls the light source 12 and the auxiliary light sources 16A and 16B to change at least one of the colors of the light, the light intensity of the light, and the operation frequency of the light according to the user music.

In the present embodiment, there are two auxiliary sensors including the microphone and the ambient light sensor, and there are three sensors including the velocity sensor, the GPS sensor, and the accelerometer. In another embodiment, there are no auxiliary sensors, and there are five sensors including the microphone, the ambient light sensor, the velocity sensor, the GPS sensor, and the accelerometer. The sensing signal corresponding to the microphone represents the frequency and the sound level of ambient sound around the environment of the electronic device 20. The sensing signal corresponding to the ambient light sensor represents the ambient light intensity of the ambient light.

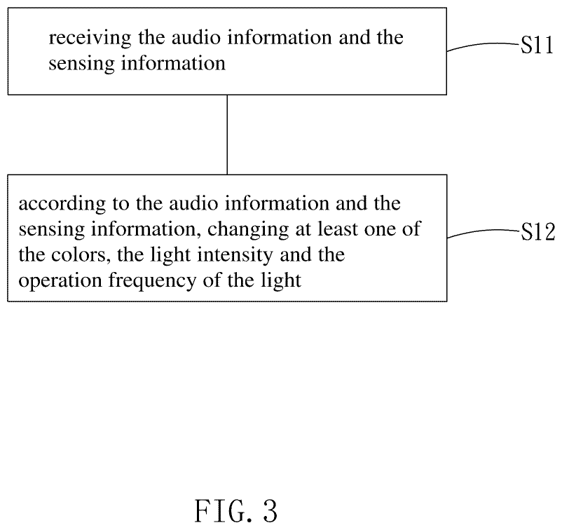

Please refer to FIG. 3, which depicts a flowchart of a method of lighting in a beverage container according to one embodiment. As shown in FIG. 3, the method of lighting in the beverage container includes step S11 and step S12. The method of lighting in the beverage container may be applicable to the lighting system shown in FIG. 1A and the lighting device 10 shown in FIG. 1B but not be limited thereto. Step S11 and step S12 would be exemplarily explained by the lighting system shown in FIG. 1A and the lighting device 10 shown in FIG. 1B as follows.

Step S11: receiving the audio information and the sensing information. As described above, the lighting device 10 receives the audio information and the sensing information from the electronic device 20. The audio information includes user music, popular music, local music and the other audio files. The sensing information includes a wealth of sensing signals, and the sensing signals, for example, represent the frequency and the sound level of the ambient sound around the environment of the electronic device 20, the ambient light intensity of the ambient light, the velocity information, the location information, and the acceleration information.

Step S12: according to the audio information and sensing information, changing at least one of the colors, the light intensity, and the operation frequency of the light.

With regard to the frequency and the sound level of the ambient sound around the environment of the electronic device 20, the microprocessor 14 maps the frequency of the ambient sound around the environment of the electronic device 20 into a light wavelength by a lookup table or an algorithm. For example, the frequency of the ambient sound within the range of 0.5 kHz to 25 kHz would be transformed into the light wavelength within the range of 400 nm to 700 nm. The microprocessor 14 maps the sound level of the ambient sound around the environment of the electronic device 20 into the light intensity by the lookup table or the algorithm. Afterwards, the microprocessor 14 controls the light source 12 to change the color and the light intensity of the light based on the mapped light intensity and the mapped light wavelength. In other words, the variations of the ambient sound around the environment are mapped into the variations of the pattern of the light to create a wide light spectrum illumination that couples in harmony with the ambient sound and to allow for the captivating visual representation of the ambient sound.

With regard to the ambient light intensity of the ambient light, the microprocessor 14 controls the light source 12 to adjust the light intensity of the light according to the ambient light intensity of the ambient light. When determining that the ambient light intensity is greater than a light intensity threshold, the microprocessor 14 controls the light source 12 to decrease the light intensity of the light; when determining that the ambient light intensity is not greater than the light intensity threshold, the microprocessor 14 controls the light source 12 to increase the light intensity of the light.

With regard to the location information, the electronic device 20 selects the local culture and the ambiance where the electronic device 20 is located from the geographical information according to the geographical orientation and the geographical position of the electronic device 20 in the location information and selects the local music reflecting the local culture and the ambiance at the geographical orientation of the electronic device 20 accordingly. Afterwards, the lighting device 10 receives the local music from the electronic device 20 by the first wireless transceiver 13, and the microprocessor 14 controls the light source 12 to change the color and the light intensity of the light based on the local music.

With regard to the velocity information and the acceleration information, the electronic device 20 determines a user action according to the velocity information, the acceleration information, and the geographical orientation of the electronic device 20, and the lighting device 10 receives the user action from the electronic device 20 by the first wireless transceiver 13. Afterwards, the microprocessor 14 controls the light source 12 to change the operation frequency of the light according to the user action. When the user action is a static action, the microprocessor 14 controls the light source 12 to emit static light. When the user action is a dynamic action such as shaking, the microprocessor 14 controls the light source 12 to emit dynamic light and synchronizes the operation frequency of the light with the velocity of the user, and the dynamic light can strobe and pulse in rhythm with the user action, thus intensifying the user experience of the beverage container with the lighting device when the user begins to dance or shake.

In another embodiment, the electronic device 20 selects the user music or the needed light template according to the user information, and the lighting device 10 receives the user music or the needed light template from the electronic device 20 by the first wireless transceiver 13. The microprocessor 14 controls the light source 12 to change the color of the light and the light intensity of the light according to the user music, or controls the light source 12 to emit the light by the needed light template to provide an enriched audio experience tailored to the user preferences.

In yet embodiment, the electronic device 20 transmits the weather information and the time information to the lighting device 10. The microprocessor 14 controls the light source 12 to change the color of the light and the light intensity of the light according to the weather information and the time information.

In the method of lighting in the beverage container of the present embodiment, the audio information and the sensing information are mapped into the variations of the pattern of the light encompassing the adjustments of the color and the light intensity of the light and the strobe effects to enhance the visual experience of the user and to create the dynamic interplay between the light and the sound.

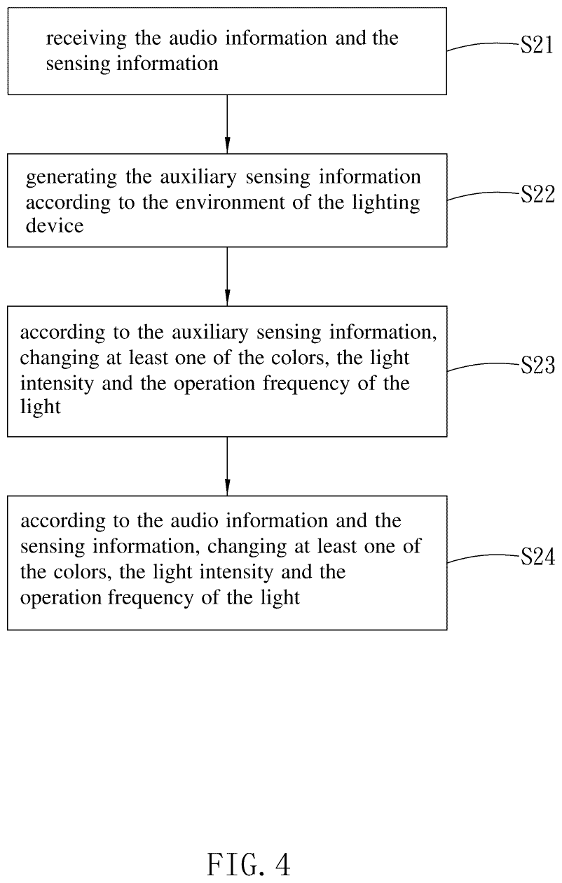

Please refer to FIG. 4, which depicts a flowchart of a method of lighting in a beverage container according to another embodiment. As shown in FIG. 4, the method of lighting in the beverage container includes step S21 to step S24, and step S21 and step S24 are similar to step S11 and step S12 and would not be repeated. Step S22 and step S23 would be exemplarily explained by the lighting system shown in FIG. 2A, the lighting device 10 shown in FIG. 2B and the electronic device 20 shown in FIG. 2C as follows.

Step S22: generating the auxiliary sensing information according to the environment of the lighting device 10. As described above, the first auxiliary sensor 17A generates the first auxiliary sensing information according to the environment of the lighting device 10, and the second auxiliary sensor 17B generates second auxiliary sensing information according to the environment of the lighting device 10. For example, the first auxiliary sensing information includes the frequency and the SPL of the ambient sound around the environment of the lighting device 10, and the second auxiliary sensing information includes the ambient light intensity of the ambient light.

Step S23: changing at least one of the colors, the light intensity and the operation frequency of the light according to the auxiliary sensing information.

With regard to the frequency and the SPL of the ambient sound around the environment of the lighting device 10, the microprocessor 14 maps the frequency of the ambient sound around the environment of the lighting device 10 into the light wavelength by the lookup table or the algorithm and maps the SPL of the ambient sound around the environment of the lighting device 10 into the light intensity by the lookup table or the algorithm. Afterwards, the microprocessor 14 controls the light source 12 and the auxiliary light sources 16A and 16B to change the color and the light intensity of the light based on the mapped light intensity and the mapped light wavelength.

With regard to the ambient light intensity of the ambient light, the microprocessor 14 controls the light source 12 and the auxiliary light sources 16A and 16B to adjust the light intensity of the light according to the ambient light intensity of the ambient light.

In the method of lighting in the beverage container of the present embodiment, the auxiliary sensing information assists the lighting device 10 in fostering a deep emotional band with the user through the interactive engagement of the lighting effects.

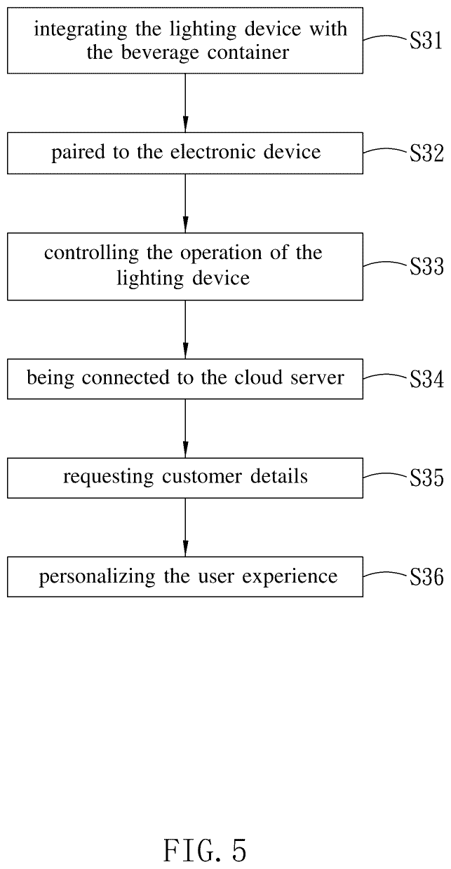

Please refer to FIG. 5, which depicts a flowchart of a method of lighting in a beverage container according to yet embodiment. As shown in FIG. 5, the method of lighting in the beverage container includes step S31 to step S36. Step S31 to step S36 would be exemplarily explained by the lighting system shown in FIG. 2A, the lighting device 10 shown in FIG. 2B and the electronic device 20 shown in FIG. 2C.

Step S31: integrating the lighting device 10 with the beverage container C1. Specifically, the lighting device 10 is attached to the bottom surface of the beverage container C1 by the attaching surface A1 to embed the lighting device 10 in the beverage container C1.

Step S32: paired to the electronic device 20. Specifically, the user utilizes the application software to give a pairing instruction to the processor 21, and the processor 21 pairs the electronic device 20 and the lighting device 10.

Step S33: controlling the operation of the lighting device 10. When the electronic device 20 is paired with the lighting device 10, the user utilizes the application software to control the processor 21 to generate control commands, and the microprocessor 14 receives the control commands from the electronic device 20 by the first wireless transceiver 13. Afterwards, the microprocessor 14 operates according to the control commands. In other words, the user utilizes the application software to indirectly control the operation of the lighting device 10.

Step S34: being connected to the cloud server 30. Specifically, the user utilizes the application software to give a connection instruction to the processor 21, and the processor 21 is connected to the cloud server 30 by the second wireless transceiver 23 according to the connection instruction. In addition, the processor 21 can be connected to the media input source 40 and the external storage device 50 by the second wireless transceiver 23. The processor 21 gathers the sensing information and the audio information from the cloud server 30, the media input source 40, and the external storage device 50.

Step S35: requesting customer details. In the present embodiment, the application software shows a prompting message to the user, and the user selects the needed light template in response to the prompting message. Afterwards, the microprocessor 14 receives the needed light template by the first wireless transceiver 13.

In another embodiment, the application software shows a prompting message to the user, and the user selects the user music in response to the prompting message. Afterwards, the microprocessor 14 receives the user music by the first wireless transceiver 13.

Step S36: personalizing the user experience. In the present embodiment, the microprocessor 14 controls the light source 12 and the auxiliary light sources 16A and 16B to change the color, the light intensity and the operation frequency of the light to personalize the lighting effects of the lighting device 10 and to enhance the user experience of the beverage container with the lighting device.

In another embodiment, the microprocessor 14 controls the light source 12 and the auxiliary light sources 16A and 16B to change the color, the light intensity and the operation frequency of the light to customize the lighting effects of the lighting device 10.

In view of the above description, in the lighting device for the beverage container, the lighting device and the beverage container integrate seamlessly, and the pattern of the light varies within the beverage container according to the audio information and the sensing information, thereby creating vibrant visual experience, thus enhancing the user experience of the beverage container with the lighting device and encouraging interactive communication with customers.

In view of the above description, in the lighting system for the beverage container and the method of lighting in the beverage container, the lighting device receives plenty of real-time data such as the audio information and the sensing information from the electronic device to synchronize the pattern of the light with the music in the audio information and to transform the sensing information into the dynamic pattern of the light, thereby fostering an enriching experience with the beverage container having the lighting device.

In addition, when the beverage container with the lighting device is exhibited, the beverage container with the lighting device not only engage consumers at a deeper level but also transforms the consumer behavior of purchasing and experiencing beverage in the beverage container into a more immersive and enjoyable journey.

What is claimed is:

1. A lighting device for a beverage container comprising:
a base affixed to the beverage container;
at least one light source disposed on the base and configured to emit light;
a wireless transceiver disposed within the base and configured to receive audio information and sensing information; and
a microprocessor disposed within the base and electrically connected to the at least one light source and the wireless transceiver, wherein the microprocessor controls the at least one light source to change at least one of colors, light intensity, and an operation frequency of the light according to the audio information and the sensing information.

2. The lighting device for the beverage container according to claim 1, further comprising:
at least one auxiliary sensor disposed on the base, electrically connected to the microprocessor, and generating and transmitting auxiliary sensing information to the microprocessor according to an environment of the lighting device, wherein the microprocessor controls the at least one light source to change at least one of the colors, the light intensity or the operation frequency of the light according to the auxiliary sensing information.

3. The lighting device for the beverage container according to claim 1, wherein the lighting device is connected to an electronic device by the wireless transceiver to receive the sensing information and obtains environment information and the audio information from a cloud server, a media input source, and an external storage device by the electronic device, and the microprocessor adjusts at least one of the colors, the light intensity, and the operation frequency of the light according to the environment information.

4. The lighting device for the beverage container according to claim 3, wherein the electronic device selects user music from the audio information according to user information and transmits the user music to the lighting device, and the step of controlling the at least one light source to change at least one of the colors, the light intensity, and the operation frequency of the light according to the audio information and sensing information by the microprocessor comprises:
according to the user music, controlling the at least one light source to change at least one of the colors, the light intensity, and the operation frequency of the light.

5. The lighting device for the beverage container according to claim 3, wherein the sensing information comprises location information, the electronic device selects local music from the audio information according to location information and transmits the local music to the lighting device, and the step of controlling the at least one light source to change at least one of the colors, the light intensity, and the operation frequency of the light according to the audio information and sensing information by the microprocessor comprises:
according to the local music, controlling the at least one light source to change at least one of the colors, the light intensity, and the operation frequency of the light.

6. The lighting device for the beverage container according to claim 1, wherein the sensing information comprises a frequency and a sound level of ambient sound and velocity information, and the step of controlling the at least one light source to change at least one of the colors, the light intensity, and the operation frequency of the light according to the audio information and sensing information by the microprocessor comprises:
according to the frequency of the ambient sound, controlling the at least one light source to change the colors of the light;
according to the sound level of the ambient sound, controlling the at least one light source to change the light intensity of the light; and
according to the velocity information, controlling the at least one light source to change the operation frequency of the light.

7. The lighting device for the beverage container according to claim 1, further comprising:
a switch disposed adjacent to the base, electrically connected to the microprocessor and configured to generate a trigger signal, wherein the microprocessor controls the at least one light source to be turned on or be turned off according to the trigger signal;
a rechargeable battery disposed within the base and generating electricity;
a power supply unit disposed within the base, electrically connected to the rechargeable battery, the at least one light source, the wireless transceiver, and the microprocessor, and distributing the electricity to the at least one light source, the wireless transceiver and the microprocessor;
a power transfer interface disposed on the base and configured to receive external power by wired power transfer or wireless power transfer; and
a battery charger disposed within the base, electrically connected to the rechargeable battery and the power transfer interface, and charging the rechargeable battery according to the external power.

8. The lighting device for the beverage container according to claim 1, wherein the base comprises an attaching surface to be attached to the container.

9. The lighting device for the beverage container according to claim 1, wherein the lighting device is wirelessly connected to a phone application, and the phone application collects user information, the sensing information and the audio information from a cloud server, a media input source and an external storage device and remotely controls operation of the lighting device.

10. A lighting system for a beverage container comprising:
an electronic device transmitting audio information and sensing information;
a lighting device communicating with the electronic device and comprising:
a base affixed to the beverage container;
at least one light source disposed on the base and configured to emit light;
a wireless transceiver disposed within the base and configured to receive the audio information and the sensing information;
a microprocessor disposed within the base and electrically connected to the at least one light source and the wireless transceiver, wherein the microprocessor controls the at least one light source to change at least one of colors, light intensity, and an operation frequency of the light according to the audio information and the sensing information.

11. The lighting system for the beverage container according to claim 10, wherein the lighting device further comprising:
at least one auxiliary sensor disposed on the base, electrically connected to the microprocessor, and generating and transmitting auxiliary sensing information to the microprocessor according to an environment of the lighting device, wherein the microprocessor controls the at least one light source to change at least one of the colors, the light intensity or the operation frequency of the light according to the auxiliary sensing information.

12. The lighting system for the beverage container according to claim 10, wherein the electronic device comprises a plurality of sensors configured to generate the sensing information and obtains environment information and the audio information from a cloud server, a media input source and an external storage device; the lighting device receives the environment information from the electronic device, and the microprocessor adjusts at least one of the colors, the light intensity, and the operation frequency of the light according to the environment information.

13. The lighting system for the beverage container according to claim 12, wherein the plurality of sensors comprises a microphone and a velocity sensor, and the sensing information comprises a frequency and a sound level of ambient sound and velocity information; the step of controlling the at least one light source to change at least one of the colors, the light intensity, and the operation frequency of the light according to the audio information and sensing information by the microprocessor comprises:
according to the frequency of the ambient sound, controlling the at least one light source to change the colors of the light;
according to the sound level of the ambient sound, controlling the at least one light source to change the light intensity of the light; and
according to the velocity information, controlling the at least one light source to change the operation frequency of the light.

14. The lighting system for the beverage container according to claim 12, wherein the plurality of sensors comprise a GPS sensor, the sensing information comprises location information, and the processor selects local music from the audio information according to location information; the lighting device receives the local music from the electronic device, and the step of controlling the at least one light source to change at least one of the colors, the light intensity, and the operation frequency of the light according to the audio information and sensing information by the microprocessor comprises:
according to the local music, controlling the at least one light source to change at least one of the colors, the light intensity, and the operation frequency of the light.

15. The lighting system for the beverage container according to claim 10, wherein the electronic device comprises a processor and a memory electrically connected to the processor, and the processor obtains user information from the memory and selects user music from the audio information according to the user information; the lighting device receives the user music from the electronic device, and the step of controlling the at least one light source to change at least one of the colors, the light intensity, and the operation frequency of the light according to the audio information and sensing information by the microprocessor comprises:
according to the user music, controlling the at least one light source to change at least one of the colors, the light intensity, and the operation frequency of the light.

16. The lighting system for the beverage container according to claim 10, wherein the electronic device is provided with application software, and the application software gathers user information, the sensing information and the audio information and controls lighting of the lighting device.

17. A method of lighting in a beverage container, for a lighting system comprising an electronic device and a lighting device configured to emit light and affixed to the beverage container, comprising:
performing steps as follows by the lighting device:
receiving audio information and sensing information from the electronic device; and
according to the audio information and sensing information, changing at least one of colors, light intensity, and an operation frequency of the light.

18. The method of lighting in the beverage container according to claim 17, further comprising steps performed by the lighting device:
generating auxiliary sensing information according to an environment of the lighting device; and
according to the auxiliary sensing information, changing at least one of the colors, the light intensity, and the operation frequency of the light.

19. The method of lighting in the beverage container according to claim 17, further comprising:
performing steps as follows by the electronic device:
generating the sensing information, and obtaining environment information and the audio information from a cloud server, a media input source, and an external storage device;
performing steps as follows by the lighting device:
receiving the environment information from the electronic device; and
according to the environment information, changing at least one of the colors, the light intensity, and the operation frequency of the light.

20. The method of lighting in the beverage container according to claim 17, wherein the sensing information comprises a frequency and a sound level of ambient sound and velocity information, and changing at least one of the colors, the light intensity, and the operation frequency of the light according to the audio information and sensing information comprising:
according to the frequency of the ambient sound, changing the colors of the light;
according to the sound level of the ambient sound, changing the light intensity of the light;
according to the velocity information, changing the operation frequency of the light.

21. The method of lighting in the beverage container according to claim 17, further comprising:
performing steps as follows by the electronic device:
obtaining user information, and selecting user music from the audio information according to the user information;
performing steps as follows by the lighting device:
receiving the user music from the electronic device;
changing at least one of the colors, the light intensity, and the operation frequency of the light according to the audio information and sensing information comprising:
according to the user music, changing at least one of the colors, the light intensity, and the operation frequency of the light.

22. The method of lighting in the beverage container according to claim 17, wherein the sensing information comprises location information, further comprising:
performing steps as follows by the electronic device:
selecting local music from the audio information according to location information;
performing steps as follows by the lighting device:
receiving the local music from the electronic device;
changing at least one of the colors, the light intensity, and the operation frequency of the light according to the audio information and sensing information comprising:
according to the local music, changing at least one of the colors, the light intensity, and the operation frequency of the light.
